(19) United States
(12) Patent Application Publication
(10) Pub. No.: US 2002/0152361 A1
(43) Pub. Date: Oct. 17, 2002

(54) Directed least recently used cache replacement method

(75) Inventors: Alvar A. Dean, Groton, MA (US); Kenneth J. Goodnow, Essex Junction, VT (US); Paul T. Gutwin, Williston, VT (US); Stephen W. Mahin, Underhill, VT (US); W. David Pricer, Charlotte, VT (US)

Correspondence Address: McGuire Woods LLP, Suite 1800, 1750 Tysons Boulevard, Tysons Corner, McLean, VA, 22102-3915, US

(73) Assignee: International Business Machines Corporation, Armonk, NY (US)

(21) Appl. No.: 09/777,365

(22) Filed: Feb. 5, 2001

(51) Int. Cl. G06F 12/12

(52) U.S. Cl. 711/160

(57) ABSTRACT

Fine grained control of cache maintenance resulting in improved cache hit rate and processor performance by storing age values and aging rates for respective code lines stored in the cache to direct performance of a least recently used (LRU) strategy for casting out lines of code from the cache which become less likely, over time, of being needed by a processor, thus supporting improved performance of a processor accessing the cache. The invention is implemented by the provision for entry of an arbitrary age value when a corresponding code line is initially stored in or accessed from the cache and control of the frequency or rate at which the age of each code is incremented in response to a limited set of command instructions which may be placed in a program manually or automatically using an optimizing compiler.

### BACKGROUND OF THE INVENTION

1. Field of the Invention

The present invention generally relates to management of contents of cache memories associated with digital data processors and, more particularly, to optimizing processor performance for particular applications by optimizing cache content.

2. Description of the Prior Art

Digital data processors have come into widespread use and extremely high performance is now generally expected. Therefore, current data processors are capable of operating at very high clock speeds and short cycle times. At the same time, to meet additional demands for increased functionality of applications programs and sophisticated graphical user interfaces (GUIs), the amount of code in an application program has been generally increasing during recent years.

To execute a program, a processor must have access to data on which operations are to be performed and instructions which define and direct the performance of particular operations. The data and instructions must be provided from some form of memory and the access time to either or both is generally a limiting factor in the overall performance of the processor.

While many different types of signal storage structures have been developed and are well-known, each type of memory structure will have different operational qualities. It is also generally the case that the greater the storage capacity of any given type of memory structure, the longer the access cycle time will be, even though all types of storage structures are being continually developed and improved to increase storage capacity and reduce access time. For example, semiconductor memories which may have capacities of many megabits have exhibited much shorter access cycle times than mass storage units having capacities several thousands of times larger. Similarly, but for different reasons, the access cycle times of dynamic memories which may be included on the same chip with the microprocessor (but may be particularly limited in storage capacity by the amount of available chip space) will be much shorter than a similarly designed memory structure of larger capacity on a different chip because of the difference of signal path length and propagation time.

For these reasons, it has been the practice to provide one or more memories, each referred to as a cache, in a hierarchy of increasing size and access cycle time (e.g. an on-chip cache, an off-chip cache and a mass memory cache buffer) between the processor and the mass memory structures to which the processor may have access. Sophisticated algorithms and methodologies have been developed for access and maintenance at each level in order to anticipate or predict data or instructions which will be needed by the processor so that data and instructions can ususally be made available to the processor rapidly when needed.

However, no such prediction arrangement can be fully effective and the performance of a processor is often considered to be limited by the cache miss rate or the relative number of times needed data or instructions are not available from the cache or top level of a cache hierarchy when called by the processor and when a longer access cycle time must be used to access the data or instructions from a different level of cache or from mass memory. For example, a proximity criterion may be used based on a theory/conjecture that when a particular line of stored data is needed by the processor, adjacent lines have an increased probability of being needed, as well, within a relatively short period of time.

Further, such algorithms must be supplemented by other algorithms which remove data from the cache since it is reasonable to assume that the probability of a line of data or instructions (already placed in a cache) being needed may diminish over time. For example, a least recently used (LRU) criterion operating on such an assumption is commonly used to remove data and/or instructions from a cache on the theory that the least recently used data or instructions is least likely of lines of data or instructions to be needed by the processor.

A combination of criteria for placing and removing data and/or instructions (hereinafter collectively referred to as “code”) is referred to as a replacement policy and the proportional number of times needed code can be found in a cache is referred to as the hit rate. (Details of the replacement policy are also largely dependent on cache size(s) provided in hardware and will therefore vary between processors.) In general, strategies for loading and discarding code run in the background as part of the operating system and may be configured for particular processor and cache hardware, possibly using autonomous cache controllers to minimize processor involvement in cache maintenance. It is the aim of the replacement policies to maximize the hit rate and, in turn, maximize processor performance. While replacement policies have become relatively sophisticated in recent years, and hit rates are, on average, relatively high (e.g. about 90% for cache size(s) currently commercially available in personal computers), a substantial margin exists for improving processor performance. However, at the present state of the art, further gains are difficult even when adaptive techniques are employed which may consume significant amounts of processor power.

### SUMMARY OF THE INVENTION

It is therefore an object of the present invention to provide a technique of cache file maintenance which significantly improves cache hit rate and processor performance without consuming significant processor power.

It is another object of the invention to provide for maximizing processor performance for particular application programs by improving cache hit rates selectively for individual applications in a processor and cache hardware independent manner.

It is a further object of the invention to provide a programming tool allowing a programmer to flexibly adjust and optimize cache performance for an application.

It is another further object of the invention to provide fine-grained control over the operation of a cache controller to determine how long particular lines of commands or instructions are maintained in cache or, conversely, how rapidly they are overwritten, based on their relative importance, as determined either by a programmer or by an optimizing compiler.

It is yet another object of the invention to provide a cache controller capable of supporting the above objects.

In order to accomplish these and other objects of the invention, a method of operating a data processor including a cache for storing a plurality of code lines is provided including steps of storing an age value of a code line when the code line is stored in or retrieved from the cache, incrementing the age value periodically at a rate, and overwriting a code line having a maximum age value among the code lines stored in the cache with another code line, wherein at least one of the age value and the rate for one code line differs from an age value or a rate of another code line.

In accordance with another aspect of the invention, a data processing apparatus comprising a cache controller, for controlling manipulation of information contained in a Least Recently Used field of a cache memory, wherein the cache memory includes cache line age fields and corresponding respective code line fields, and arrangement for controlling contents of said cache memory based on the information in the cache line age fields.

In accordance with a further aspect of the invention, a computer programming tool for use in an application that can be run on a computer system wherein a cache controller implements a Least Recently Used algorithm is provided comprising an arrangement for manipulating cache line age data of a line in a cache in accordance with change, over time, of differing probabilities of respective cache lines being called, and an arrangement for replacing a least recently used line in the cache in response to the age data.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a high level block diagram of the processor, cache controller and cache of a data processing arrangement in accordance with the invention, FIG. 2 is a graph illustrating flexibility of cache maintenance control in accordance with the invention, and FIG. 3 is a flow chart illustrating operation of the invention.

### DETAILED DESCRIPTION OF A PREFERRED EMBODIMENT OF THE INVENTION

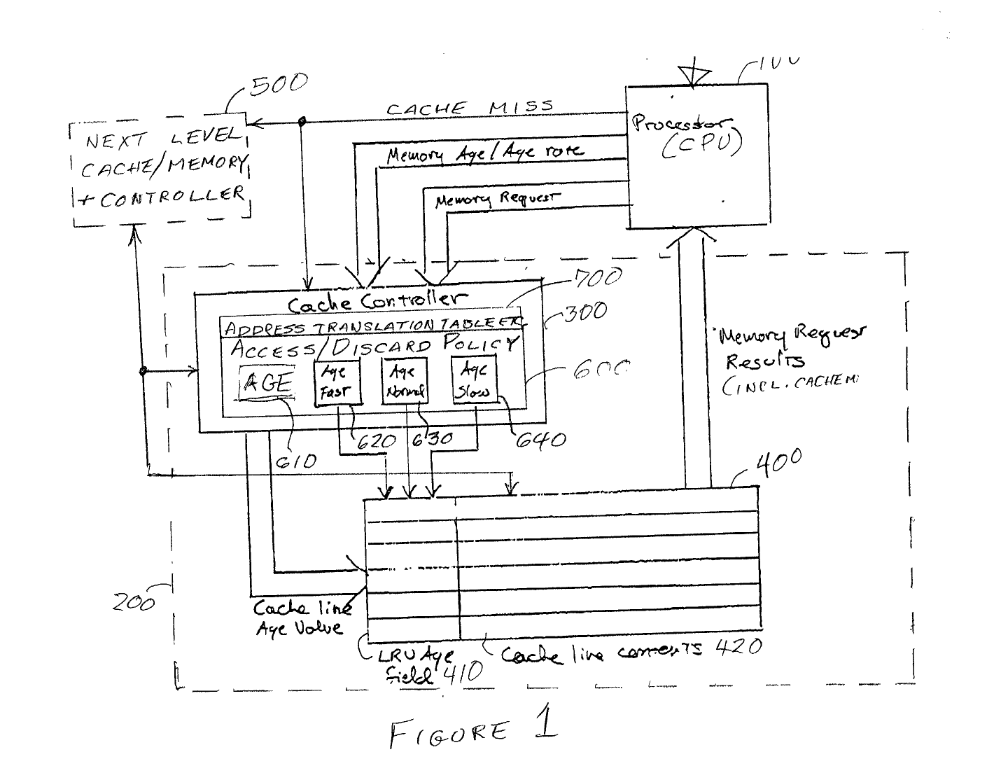

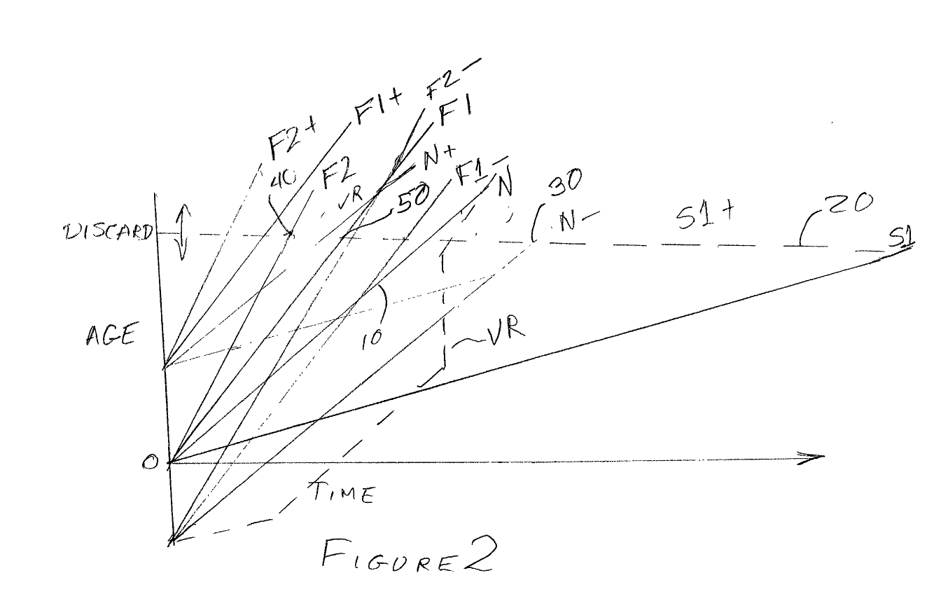

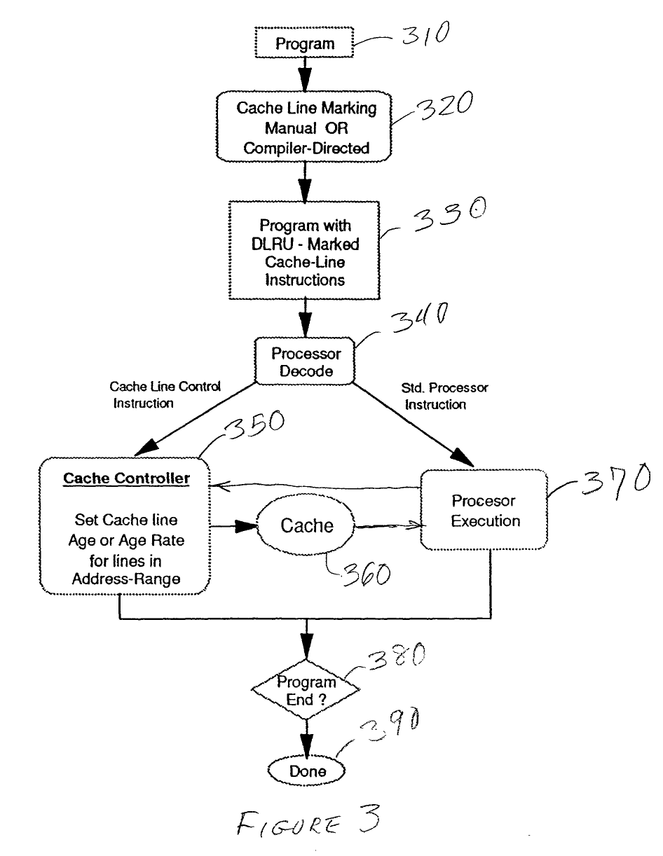

Referring now to the drawings, and more particularly to FIG. 1, there is shown a high-level block diagram of a portion of a data processing arrangement including a central processing unit (CPU) 100 and a (preferably on-chip) cache 200 including a cache controller 300 and a cache memory 400. A further/next cache level or mass storage memory is depicted at 500 to indicate that the invention can be implemented to advantage at any or all levels of memory/cache associated with the CPU 100. The cache controller 300 preferably includes an autonomous processor 600 for implementing a replacement or access/discard policy to determine the code maintained in the cache memory 400 at any given time. Alternatively, action of the cache memory controller can be controlled or entirely performed by the CPU 100.

Those skilled in the art may recognize some similarities of the gross organization of CPU 100, cache 200 and a further memory or cache level 500. However, the nature of the cache controller 300 and the data contained and manipulated in the cache memory 400 are quite different from known systems and result in much different operation in some respects and numerous meritorious functions and significant gains in processor efficiency and performance not available in the prior art. By the same token, the invention can duplicate the limited functions of known cache systems and the invention is fully compatible with software which does not exploit the invention.

The details of the access portion of the replacement policy are largely unimportant to the practice of the invention but are preferably considered in implementation of the discard portion of the replacement policy. However, in contrast with the prior art, the access policy or at least some aspects thereof are preferably specified by the programmer in a given application program or at least generally known (e.g. a proximity criterion as alluded to above) to the programmer during application development. As will be discussed in greater detail below, the invention largely operates through the discard portion of the replacement policy to remove code with lower probability of being needed so that code with greater probability of being needed may be prefetched into the cache.

To do so, the cache memory 400 includes a cache line age field 410 as well as corresponding, respective code line fields 420. In a conventional cache memory utilizing a LRU discard policy as is conventional at the present time, either a time stamp or an age value of zero is applied to the line age field 410 when a line of code is fetched (in response to a processor call) or prefetched (in response to a prediction of the access portion of the replacement policy) into the cache memory. If the latter, the age field of all lines will be periodically incremented. If the former, a time-out register and comparator will be provided to determine a time at which the line has been in cache memory a sufficient time that probability of being needed by the processor is so diminished as to be significantly less than the probability of processor need for other lines of code. In either case, the time stamp or age field is reset if and when the line of code is actually called by the processor.

Thus, the duration of storage of each line (or group of lines) in the cache memory can be determined at any point in time and the duration of storage will be greatest for the least recently used line or group of lines of code. Therefore, a (possibly variable) age threshold can be imposed at any time to discard one or more code lines and to prefetch other lines. Similarly, upon a cache miss, one or more least recently used lines of code can be selected to be discarded to allow room for storage of the lines called by the processor and other lines which are predicted (e.g. by a proximity algorithm) to have a high probability of being needed based on the line called and causing a cache miss.

This conventional function is depicted by line N of FIG. 2, also indicated by reference numeral 10. (No other portion of FIG. 2 or any other figure is admitted to be prior art as to the present invention.) The remainder of FIG. 2 is intended to illustrate the flexibility in replacement policy provided by the present invention relative to the function depicted by line N (10). Specifically, known cache maintenance arrangements and replacement policies implementing a least recently used (LRU) criterion exhibit a fixed and linear relationship between age of a line in cache memory and time.

That is, the point at which a line or group of lines of code is discarded from cache memory to be replaced by other lines of code is determined in accordance with threshold 20. This threshold 20 may be fixed or variable with, for example, cache misses or reduction in hit rate below an acceptable level. Thus, with some minor possible exceptions or adjustments based on current processor operating conditions, replacement of a line or group of lines of code will occur upon a certain age or time in cache memory without being called. In any case, each line of code stored in cache is treated in the same manner and subjected to the same LRU criterion at any given time. At the present state of the art, additional criteria can be added or varied within a given replacement policy only with substantial difficulty and still cannot implement a policy that allows consideration of code line content in causing replacement of lines of code in a cache.

The inventors have observed that the probability of a code line being needed within a given period of time may (or may not) vary widely with code line content and, in any event, probability of a code line being called is particularly variable with context in a particular application program. For example, a mathematical operation may have an extremely low probability of being called during a word processing application while certain graphics operations may have any of a wide variety of probabilities of being called depending on both current operations on data and particular possible actions in regard to a graphic user interface (GUI).

Nevertheless, the inventors have also recognized that algorithms capable of evaluating code line content would necessarily be very complex and difficult to implement, particularly in regard to content and would require substantial processing power overhead to operate, particularly to accommodate wide variation among different application contexts. Further, any such arrangement would experience a very short useful lifetime before substantial obsolescence given current rapid development of different and highly specialized software applications.

Accordingly, the invention provides, for the application software developer, a projected probability that a prefetched line of code will be called within any particular application context, and the added advantages of simple implementation and rapid execution.

Specifically, as will be discussed in greater detail below, the invention provides the software developer with the ability to direct or modify the performance of a LRU replacement/discard policy and thus supply “hints” to the processor and cache controller for optimizing cache maintenance and processor performance. Thus, the invention is aptly referred to as implementing a “directed” least recently used (DLRU) procedure to optimize cache hit rate and processor performance.

Returning now to FIG. 1, the access/discard policy section 600 of cache controller 300 includes an arrangement such as a register or separate registers for conveying information from processor 100 in regard to age 610, and/or controlling manipulation of information contained in the LRU age field 410 of respective code lines, preferably in regard to aging rate 620 (fast) and 640 (slow) as well as for normal aging rate 630 which may be implemented as a default. More specifically, when the cache controller 300, possibly in response to direct control from CPU 100 (e.g. a cache miss) discards a line or group of lines from cache memory 400 and fetches or prefetches one or more lines of memory from a next hierarchical stage of cache or mass memory, the invention provides for an arbitrary age, which may be positive or negative (as well as the conventional zero age), to be placed in the LRU age field. These values are manipulated (e.g. incremented), either actually or effectively, over time to provide a basis for when discarding and replacement is to be performed.

Referring again to FIG. 2, setting the age to zero and manipulating the age data normally as in the conventional cache controller causes the line to be discarded and replaced when the age reaches a fixed or possibly variable threshold, indicated at 30 at the intersection of threshold 20 and line N (10). Setting a lesser or negative age (or earlier time stamp), the line can be forced to be maintained in cache for a longer period of time as shown by line N−, even if the age data manipulation is performed normally. Setting a greater or positive age (or later time stamp) can be used to maintain the code line for a shorter time even if aging manipulations are performed normally, as indicated by line N+.

Thus substantially greater flexibility is provided in allowing control of the time a code line is maintained in cache by modification of storage time or age when the code line is initially stored in cache by the extremely simple expedient of providing for storage of an accurate or false time stamp or age in LRU field 410 at element/register 610. Specification of the time can be performed by execution of a single instruction, as will be discussed in greater detail below. Absence of such an instruction results in an entry and manipulation consistent with known systems to assure compatibility with existing software.

Similarly, The inventors have appreciated that while it may be generally true that the likelihood or probability of calling a code line previously predicted as having a high probability of being called diminishes with time (corresponding to a positive slope of the lines in FIG. 2), the change in probability with time may differ from other code lines or the change of current context of the portion of an application program being executed. Therefore, elements/registers 620, 640 are provided to emulate faster and slower changes of probability with time by simulating faster and slower aging of code lines, respectively. Assuming a cache storage time entry of zero, faster aging (relative to N) is depicted by line F1 and slower aging (relative to N) is depicted by line S1 in FIG. 2 and is evident in the greater or lesser slope of the respective lines.

Different degrees or variability of faster or slower aging can be provided in the same manner and a second faster rate of aging is depicted by line F2, resulting in even earlier discard and replacement of a cache data line (at 40) than for F1 (at 50). Also, the invention is not limited to providing linear functions of aging (although such is preferred for simplicity and ease of implementation and efficiency of processing) but non-linear aging functions reflecting non-linearly variable decrease in probability with time can be provided in accordance with the invention, as well, by, for example, adjusting an increment or period of application of an aging manipulation to data or resetting an age in respective LRU age fields 410 as can be visualized from variable aging function VR depicted with a dashed line in FIG. 2.

This function, as illustrated, begins with a negative age and ages slowly until a normal aging rate is assumed, then the age is reset to instantaneously increased age before a fast aging function is commanded. It should be appreciated that any code line can thus be made to exhibit any aging function and that the vertical position of any depicted function at any point in time after initial storage in cache should generally correspond to the relative probability of that code line being needed a corresponding time after storage in cache. It can be appreciated from FIG. 2 that the invention provides a powerful flexibility for accommodating relative probabilities of different code lines over time and can thus greatly improve cache hit rates by accommodating those relative probabilities in accordance with relative importance of the code line in different portions of different applications.

The particular (linear of linear segment of a variable function) aging function illustrated in FIG. 2 is chosen by use of one or, at most, two instructions of a small instruction set used to implement the invention. Each of the instructions of the instruction set, when executed by CPU 100 or the cache controller 300 either controls setting of an initial age, when stored or the initial age to which the age field 410 is reset when the code line is called or sets the aging rate for the code line. An exemplary set of instructions in pseudocode would be:

| | |
|---|---|
| NEW<addr-range> | Sets LRU age bits to maximum |
| OLD<addr-range> | Sets LRU age bits to minimum |
| CRIT<addr-range> | Sets LRU aging rate to minimum |
| NORM<addr-range> | Sets LRU aging rate to normal |
| TEMP<addr-range> | Sets LRU aging rate to maximum. |

Of course, NORM corresponds to default aging rate and no separate command is necessary to set the initial age to zero. Further, it should be appreciated that different initial ages and aging rates can be set as well as minimum (minimum age or age slowly) and maximum (maximum age or age rapidly).

The cache line marking instructions thus set only a single data value and can be executed very quickly. Therefore, extremely little if any processor overhead is required since the instructions are preferably detected and routed to the cache controller at the instruction decoding stage and thus may be carried out autonomously and concurrently with normal processor operations.

These instructions can be inserted in applications, for example, as a marking subroutine or preceding an instruction or the first instruction of a group of instructions which may be prefetched and thus would occupy the line at the beginning of an address range which may be predicted as likely to be needed by the processor. Alternatively, such instructions may be placed at any early location in the program and the age and/or age rate parameters stored for application to a code line range whenever that code line range is placed in cache.

This insertion can be performed manually by an assembly level programmer during, for example, assembly or upgrading of an application program or automatically generated by an optimizing compiler. The initial age and/or rate of aging can be determined automatically based on the type of operation that is represented by the instructions. For example, a line at a branch address may be prefetched in accordance with the loading or execution of a conditional branch instruction and provided with a maximum age or maximum aging rate since the code line is unlikely to be called if the branch instruction executes without calling the code line.

This instruction set could be used to particular advantage in a case where possibly extensive initialization code is to be run and then quickly cast out of cache. An example of use of the above instructions for this purpose would be:

init: CRIT main-init // begin initialization loop, mark lines for slow aging

BRZ main

NEW main-init //refresh LRU bits

JMP init //Go back around around loop

main: OLD main-init //mark initialization loop for cast out

This use of the commands first sets the aging rate at minimum to retain the specified lines of the initialization loop in cache as long as possible and, upon completion of execution, re-marks them to be cast out as soon as possible since they will not be required again with the session.

Another example in which the invention is of particular advantage is where several segments of code are marked with their relative importance. An example of the use of the above instructions would be:

sub1: TEMP esub1-sub1 //This subroutine is used only once

esub1: RET //Return to main body

sub2: CRIT esub2-sub2 //this is critical code used often, maintain as long as possible

NEW esub2-sub2 // Mark the whole range as new

esub2: RET //Return to main body

This code would establish the aging of a code range to be as slow as possible while setting the age to a minimum value upon every execution.

To summarize the foregoing, a flow chart summarizing use and operation of the invention is shown in FIG. 3 which, for convenience, includes both the application of the invention to a program and the operation of the invention during the execution of the program. It will be recognized by those skilled in the art that the process of FIG. 3 could also be performed as a single sequence of operations and/or that some operations could be performed concurrently.

Specifically, program 310 could be either an existing application or be in the process of development and cache line marking 320 could be formed concurrently with application development or applied later either manually or by an optimizing compiler. Such marking results in a program of the original functionality but with DLRU-marked cache line instructions 330.

When the program is run, blocks of instruction code lines are fetched under processor control or prefetched in accordance with a prediction technique which is not of importance to the practice of the invention. These code lines are decoded to a form suitable for use by the processor as depicted at 340. However, in the course of this process DLRU-marked lines are detected and forwarded to the cache controller so that the age and/or aging rate can be set for each code line as it is placed in cache 360. Standard instructions, if not prefetched for placement in cache are forwarded to the processor for execution 370. If execution requires code lines that are stored in the cache, the processor communicates directly with the cache controller 350 to obtain the needed code lines from cache 360. When the program completes (380), the operation of the invention is completed (390).

In view of the foregoing, it is seen that the invention provides fine-grained control and much increased flexibility of function of cache maintenance, supporting improved processor performance through significantly increased cache hit rates. The increased cache hit rates are achieved in a very simple fashion which can be implemented with markings and/or instructions that can be performed manually or by an optimizing compiler. Since the invention operates only on age values, it is unconditionally compatible with existing systems employing a LRU-based cache control algorithm and, unless coded in an irrational manner contrary to known relative importance of code lines, worst-case performance is at least as good as an LRU-based arrangement and often significantly better.

While the invention has been described in terms of a single preferred embodiment, those skilled in the art will recognize that the invention can be practiced with modification within the spirit and scope of the appended claims.

Having thus described our invention, what we claim as new and desire to secure by Letters Patent is as follows:

1. A method of operating a data processor including a cache for storing a plurality of code lines, said method including steps of
storing an age value of a code line when said code line is stored in or retrieved from said cache,
incrementing said age value periodically at a rate, and
overwriting a code line having a maximum age value among said code lines stored in said cache with another code line, wherein at least one of said age value and said rate for one said code line differs from an age value or a rate of another code line.

2. A method as recited in claim 1, including the further step of marking respective lines of code of an application for performing a said storing or incrementing step using a compiler.

3. A method as recited in claim 1, including the further step of marking respective lines of code of an application for performing a said storing or incrementing step during development of said application.

4. Data processing apparatus comprising
a cache controller, for controlling manipulation of information contained in a Least Recently Used field of a cache memory, wherein said cache memory includes a cache line age fields and corresponding respective code line fields, and
means for controlling contents of said cache memory based on said information in said cache line age fields.

5. An apparatus as recited in claim 4, wherein the central processor unit is programmed to provide said cache controller.

6. An apparatus as recited in claim 4, wherein said cache controller sets an age or time value in accordance with a time during which there is a given probability of a corresponding cache line being called by said data processing apparatus.

7. An apparatus as recited in claim 4, wherein said cache controller alters an age or time value in accordance with an estimated change of probability over time of a corresponding cache line being called by said data processing apparatus.

8. An apparatus as recited in claim 6, wherein said cache controller alters said age or time value in accordance with an estimated change in probability over time of a corresponding cache line being called by said data processing apparatus.

9. A computer programming tool for use in an application that can be run on a computer system wherein a cache controller implements a Least Recently Used algorithm, said tool comprising
means for manipulating cache line age data of a line in a cache in accordance with change, over time, of differing probabilities of respective cache lines being called, and
means for replacing a least recently used line in said cache in response to said age data.

10. A tool as recited in claim 9, wherein said means for manipulating age data sets age data to a specific age value.

11. A tool as recited in claim 9, wherein said means for manipulating age data modifies said age data at multiple rates whereby multiple rates at which a cache line can age are provided.

12. A tool as recited in claim 9, wherein said means for manipulating age data modifies said age data at multiple rates whereby multiple rates at which a cache line can age are provided.

13. The computer program tool of claim 9, wherein cache line marking instructions for manipulating cache line age data are automatically generated by a compiler.

14. The computer program tool of claim 9, wherein the cache line marking instructions are manually coded in an application by an assembly level programmer.
